(19) United States
(12) Patent Application Publication
(10) Pub. No.: US 2009/0096396 A1
(43) Pub. Date: Apr. 16, 2009

(54) Method for Determining the Rotor Position of a Separately Excited Rotating Electrical Machine

(75) Inventors: Marco Sieber, Windisch (CH); Thorsten Harder, Tegerfelden (CH); Patrick Bohren, Lenzburg (CH)

Correspondence Address: BUCHANAN, INGERSOLL & ROONEY PC, POST OFFICE BOX 1404, ALEXANDRIA, VA, 22313-1404, US

(73) Assignee: ABB SCHWEIZ AG, Baden (CH)

(21) Appl. No.: 12/251,481

(22) Filed: Oct. 15, 2008

(30) Foreign Application Priority Data
Oct. 16, 2007 (EP) 07118569.8

(51) Int. Cl. H02P 6/18

(52) U.S. Cl. 318/400.33

(57) ABSTRACT

A method is specified for determining the rotor position of a separately excited rotating electrical machine which machine has a stator winding set and a rotor winding set and in which method the stator winding set is fed from an associated converter unit, and the rotor winding set is fed from an associated exciter unit. First of all, the stator winding set is short-circuited by means of the converter unit. An exciter voltage signal is then applied to the rotor winding set by means of the exciter unit, which exciter voltage signal has a change from a variable first voltage value to a variable second voltage value: Furthermore, the stator current (Isa, Isb, Isc) is determined in each winding of the stator winding set, and a rotor position angle (θ) is calculated.

### RELATED APPLICATION

This application claims priority under 35 U.S.C. §119 to European Patent Application No. 07118569.8 filed in Europe on Oct. 16, 2007, the entire content of which is hereby incorporated by reference in its entirety.

### TECHNICAL FIELD

The disclosure relates to the field of operating methods for rotating electrical machines. It is based on a method for determining the rotor position and/or for determining the magnetic flux angle of a separately excited rotating electrical machine.

### BACKGROUND INFORMATION

A normal modern separately excited rotating electrical machine, such as a synchronous machine, has a stator winding set and a rotor winding set, with the stator winding set typically being fed from an associated converter unit, and the rotor winding set being fed from an exciter unit in order to form magnetic excitation. The rotor position in a rotating electrical machine such as this is nowadays determined mainly by means of rotary encoders, which produce the desired rotor position, that is to say the rotor position angle when the rotor is stationary, and the magnetic flux angle. The knowledge of the position of the rotor and the position of the magnetic flux vector is typically required as one of normally a plurality of input variables for the control of the machine. However, rotary encoders are highly susceptible to mechanical loads and accordingly often fail or produce incorrect rotor position angle values. Furthermore, installation is complex since the rotary encoder itself and furthermore the wiring must be fitted to the machine, which is labor-intensive and costly. Furthermore, a rotary encoder such as this requires continual maintenance, involving additional effort.

### SUMMARY

A method is disclosed for determining the rotor position of a separately excited rotating electrical machine, which method can be implemented very easily, is robust, and does not require any rotary encoders.

A method is disclosed for determining the rotor position of a separately excited rotating electrical machine which machine has a stator winding set and a rotor winding set, in which the stator winding set is fed from an associated converter unit, and the rotor winding set is fed from an associated exciter unit, wherein the stator winding set is short-circuited by means of the converter unit, an exciter voltage signal is applied to the rotor winding set by means of the exciter unit, which exciter voltage signal has a change from a variable first voltage value to a variable second voltage value, the stator current (Isa, Isb, Isc) is determined in each winding of the stator winding set, and a rotor position angle (θ) is calculated from the x-component (Isx) of the space-vector transformation of the stator currents (Isa, Isb, Isc) and from the y-component (Isy) of the space-vector transformation of the stator currents (Isa, Isb, Isc).

This and further objects, advantages and features of the present disclosure will become clear from the following detailed description of exemplary embodiments of the disclosure, in conjunction with the drawing.

### BRIEF DESCRIPTION OF THE DRAWINGS

In the figures:

FIG. 1 shows a first exemplary time profile of the exciter voltage signal on the rotor winding set of the separately excited rotating electrical machine for an exemplary method according to the disclosure,

FIG. 2 shows a second exemplary time profile of the exciter voltage signal on the rotor winding set of the separately excited rotating electrical machine for an exemplary method according to the disclosure,

FIG. 3 shows a third exemplary time profile of the exciter voltage signal on the rotor winding set of the separately excited rotating electrical machine for an exemplary method according to the disclosure, and

FIG. 4 shows a fourth exemplary time profile of the exciter voltage signal on the rotor winding set of the separately excited rotating electrical machine for an exemplary method according to the disclosure.

Fundamentally, identical parts are provided with the same reference symbols in the figures.

### DETAILED DESCRIPTION

In an exemplary method according to the disclosure for determining the rotor position of a separately excited rotating electrical machine, the machine has a stator winding set and a rotor winding set, with the stator winding set being fed from an associated converter unit, and with the rotor winding set being fed from an associated exciter unit. According to the disclosure, the stator winding set is first of all short-circuited by means of the converter unit. An exciter voltage signal is then applied to the rotor winding set by means of the exciter unit, which exciter voltage signal has a change from a variable first voltage value to a variable second voltage value. Furthermore, the stator current is determined in each winding of the stator winding set and a rotor position angle is calculated from the x—component of the space-vector transformation of the stator currents and from the y-component of the space-vector transformation of the stator currents, with this rotor position angle representing the sought rotor position.

The rotor position of a separately excited rotating electrical machine can therefore advantageously be determined using the method according to the disclosure without any rotary encoders, with all of their disadvantages, thus resulting overall in a robust method, which can be implemented very easily, for determining the rotor position of a rotating electrical machine. The method according to the disclosure is particularly suitable when the rotor is stationary or the rotor is rotating very slowly.

In an exemplary method according to the disclosure for determining the rotor position of a separately excited rotating electrical machine, the machine has a stator winding set and a rotor winding set, with the stator winding set being fed from an associated converter unit, and with the rotor winding set being fed from an associated exciter unit. By way of example, one such separately excited rotating electrical machine is a synchronous machine, although any types of separately excited rotating electrical machines are feasible. Both the stator winding set and the rotor winding set each, for example, have three windings, although more or fewer windings are also feasible. According to the disclosure, the stator winding set is first of all short-circuited by means of the converter unit. This is done by appropriately operating the controllable power semiconductor switches in the converter unit. An exciter voltage signal Uerr is then applied to the rotor winding set by means of the exciter unit, which exciter voltage signal Uerr has a change from a variable first voltage value U1 to a variable second voltage value U2. This change, that is to say this transient process in the profile of the exciter voltage signal Uerr, results in a stator current Isa, Isb, Isc in each winding of the stator winding set. Furthermore, the stator current Isa, Isb, Isc is determined in each winding of the stator winding set. If there are three stator windings, for example, this can be done by measuring two stator currents Isa, Isb, and by calculating the third stator current Isc from the two measured stator currents Isa, Isb. All the stator currents Isa, Isb, Isc can, of course, also be determined by measurement. A rotor position angle θ is then calculated from the x-component Isx of the space-vector transformation of the stator currents Isa, Isb, Isc and from the y-component Isy of the space-vector transformation of the stator currents Isa, Isb, Isc, which then represents the sought rotor position or the position of the magnetic flux vector.

The rotor position of a separately excited rotating electrical machine can therefore advantageously be determined using the method according to the disclosure without any rotary encoders, with all of their disadvantages, thus resulting overall in a robust method, which can be implemented very easily, for determining the rotor position. The method according to the disclosure is particularly suitable when the rotor is stationary or the rotor is rotating very slowly.

In general, the space-vector transformation of three variables a, b, c is normally defined as follows:

$$x = \frac{2}{3} ( a - \frac{b + c}{2} )$$

$$y = \frac{b - c}{\sqrt{3}}$$

where x is the x-component of the space-vector transformation of the variables a, b, c and y is the y-component of the space-vector transformation of the variables a, b, c.

If the first voltage value U1 is now less than the second voltage value U2, the rotor position angle θ is advantageously calculated from the x-component Isx of the space-vector transformation of the stator currents Isa, Isb, Isc and from the y-component Isy of the space-vector transformation of the stator currents Isa, Isb, Isc using the following formula:

$$θ = arctan ( \frac{Isy}{Isx} ) + π .$$

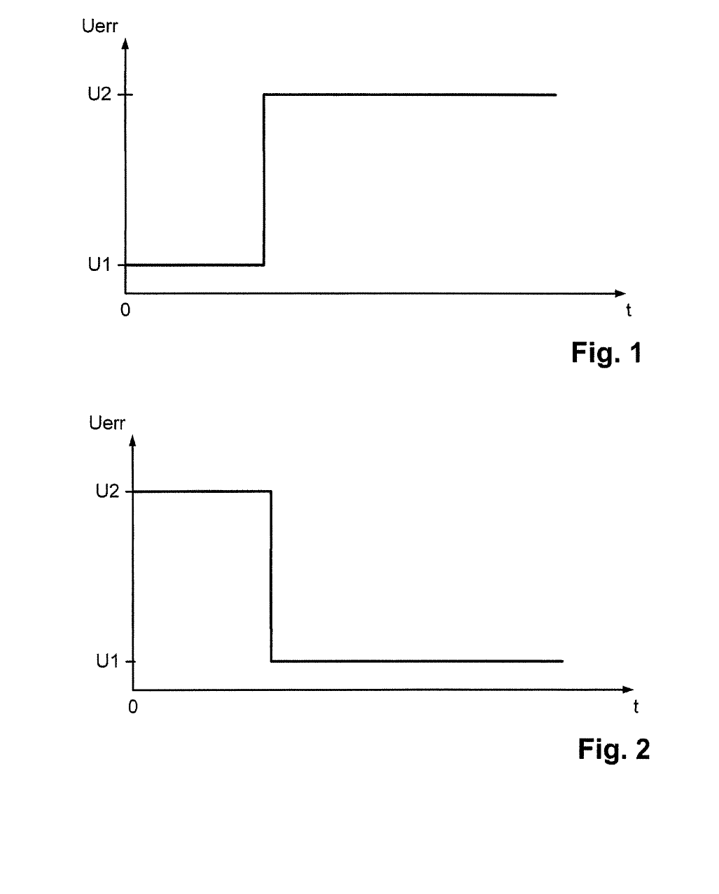

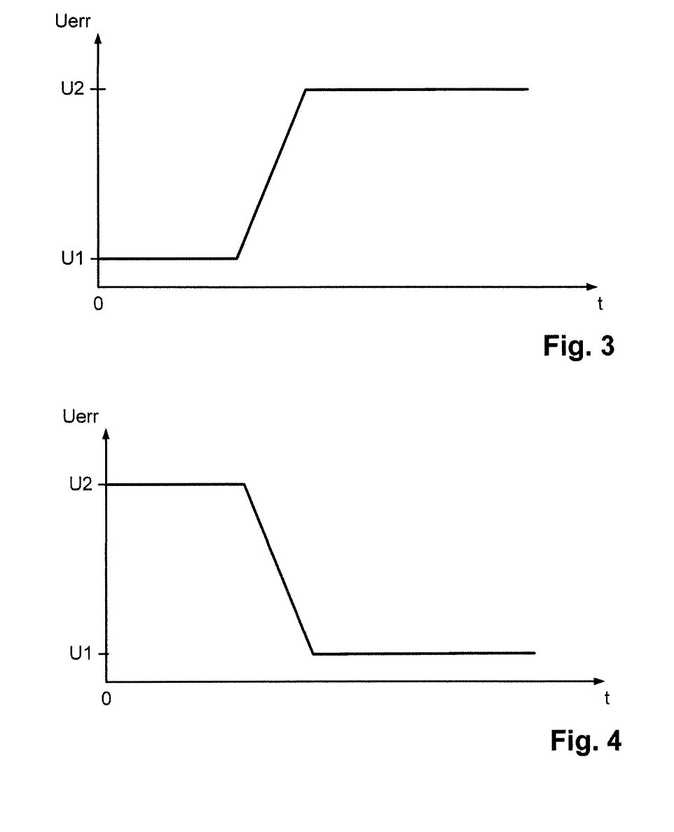

In this context, FIG. 1 shows a first time profile, and FIG. 3 a third time profile, of the exciter voltage signal Uerr on the rotor winding set of the separately excited rotating electrical machine when using the method according to the disclosure, with the first voltage value U1 being less than the second voltage value U2.

If, in contrast, the first voltage value U1 is greater than the second voltage value U2, the rotor position angle θ is advantageously calculated from the x-component Isx of the space-vector transformation of the stator currents Isa, Isb, Isc and from the y-component Isy of the space-vector transformation of the stator currents Isa, Isb, Isc using the formula:

$$θ = arctan ( \frac{Isy}{Isx} ) .$$

In this context, FIG. 2 shows a second time profile, and FIG. 4 a fourth time profile, of the exciter voltage signal Uerr on the rotor winding set of the separately excited rotating electrical machine when using the method according to the disclosure, with the first voltage value U1 being greater than the second voltage value U2. The calculations of the rotor position angle θ as mentioned above are accordingly very simple and can be carried out without any problems, for example as a calculation routine in a software program for a digital signal processor.
It has been found that it is particularly advantageous to set the first voltage value U1 to 0 V and to set the second voltage value U2 to the rated exciter voltage value. It is, however, just as feasible to set the first voltage value U1 to the rated exciter voltage value and the second voltage value U2 to 0 V.

According to the exemplary time profiles of the exciter voltage signal Uerr shown in FIG. 1 and FIG. 2, the change from the first voltage value U1 to the second voltage value U2 can occur essentially suddenly. According to the exemplary time profiles of the exciter voltage signal Uerr shown in FIG. 3 and FIG. 4, the change from the first voltage value U1 to the second voltage value U2 can occur essentially in the form of a ramp. The sudden change or change in the form of a ramp as mentioned above in the time profile of the exciter voltage signal Uerr can advantageously be achieved without major effort, and thus very easily. In addition to this sudden change or change in the form of a ramp, alternative transient processes or steady-state profiles which have a change from a first voltage value U1 to a second voltage value U2 are, of course, also feasible.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method for determining the rotor position of a separately excited rotating electrical machine which machine has a stator winding set and a rotor winding set,
in which the stator winding set is fed from an associated converter unit, and the rotor winding set is fed from an associated exciter unit,
wherein the stator winding set is short-circuited by means of the converter unit,
an exciter voltage signal is applied to the rotor winding set by means of the exciter unit, which exciter voltage signal has a change from a variable first voltage value to a variable second voltage value,
the stator current (Isa, Isb, Isc) is determined in each winding of the stator winding set, and a rotor position angle (θ) is calculated from the x-component (Isx) of the space-vector transformation of the stator currents (Isa, Isb, Isc) and from the y-component (Isy) of the space-vector transformation of the stator currents (Isa, Isb, Isc).

2. The method as claimed in claim 1, wherein, if the first voltage value is less than the second voltage value, the rotor position angle (θ) is calculated from the x-component (Isx) of the space-vector transformation of the stator currents (Isa, Isb, Isc) and from the y-component (Isy) of the space-vector transformation of the stator currents (Isa, Isb, Isc) using the formula:
$$θ = arctan ( \frac{Isy}{Isx} ) + π .$$

3. The method as claimed in claim 1, wherein, if the first voltage value is greater than the second voltage value, the rotor position angle (θ) is calculated from the x-component (Isx) of the space-vector transformation of the stator currents (Isa, Isb, Isc) and from the y-component (Isy) of the space-vector transformation of the stator currents (Isa, Isb, Isc) using the formula:
$$θ = arctan ( \frac{Isy}{Isx} ) .$$

4. The method as claimed in claim 2, wherein the first voltage value is set to 0 V and the second voltage value is set to the rated exciter voltage value.

5. The method as claimed in claim 3, wherein the first voltage value is set to the rated exciter voltage value, and the second voltage value is set to 0 V.

6. The method as claimed in claim 1, wherein the change from the first voltage value to the second voltage value takes place essentially suddenly.

7. The method as claimed in claim 1, wherein the change from the first voltage value to the second voltage value takes place essentially in the form of a ramp.

8. The method as claimed in claim 5, wherein the change from the first voltage value to the second voltage value takes place essentially suddenly.

9. The method as claimed in claim 5, wherein the change from the first voltage value to the second voltage value takes place essentially in the form of a ramp.

10. A system for determining a rotor position of a rotating electrical machine, comprising:
a separately excited rotating electrical machine having a stator winding set and a rotor winding set;
a converter unit associated with the stator winding set; and
an exciter unit associated with the rotor winding set, wherein when the stator winding set is short-circuited by the converter unit, an exciter voltage signal is then applied to the rotor winding set by the exciter unit, which exciter voltage signal changes from a variable first voltage value to a variable second voltage value, and wherein a stator current is determined in each winding of the stator winding set, and a rotor position angle is calculated.

11. The system as claimed in claim 10, wherein said rotor position angle is calculated based on an x-component of a space-vector transformation of the stator currents and from a y-component of the space-vector transformation of the stator currents.
